(19) United States
(12) Patent Application Publication
(10) Pub. No.: US 2009/0004995 A1
(43) Pub. Date: Jan. 1, 2009

(54) CASE SUBSTRATE

(75) Inventors: Hun-Jen CHEN, Sanchong City (TW); Sung-Yi HO, Kaohsiung City (TW); Yi-Ru LIU, Heping Township (TW)

Correspondence Address: Workman Nydegger;1000 Eagle Gate Tower, 60 East South Temple, Salt Lake City, UT, 84111, US

(73) Assignee: MICRO-STAR INT'L CO., LTD., Jung-He City (TW)

(21) Appl. No.: 11/856,763

(22) Filed: Sep. 18, 2007

(30) Foreign Application Priority Data
Jun. 29, 2007 (TW) 096210689

(51) Int. Cl. H04B 1/08

(52) U.S. Cl. 455/347; 398/202

(57) ABSTRACT

A case substrate including a base material and a coating layer coated on the base material. The coating layer has a hollow-out opening corresponding to the position of an infrared receiver, such that infrared rays can pass through the base material from the hollow-out opening and thus being received by the receiver.

### BACKGROUND OF THE INVENTION

1. Field of the Invention

The present invention relates to a case substrate, and more particularly to a housing component for an electronic product having an infrared device.

2. Related Art

As the development of the technology for manufacturing electronics and information products, the electronics often transfer data with each other. Most electronics, for example, personal computers, notebook computers, personal digital assistants (PDAs), and mobile phones, etc., have an interface for performing data transmission with other systems, and meanwhile, an infrared module with the advantages of simple transmission principle, small volume, and low cost has recently become the mainstream technology of short distance wireless transmission on the market, since the communication quality is not interfered by excessive microwave noises.

The cases of most electronics on the market are fabricated by injection molding on plastics. With the current injection molding technology, in the procedure of manufacturing the case, a mixing process can be selected to manufacture the case with a predetermined color. However, due to the physical light wave characteristics of the infrared rays in the infrared rays transmission loop, such as the infrared rays can only pass through the object made of transparent materials, instead of an obstacle coated with paint on the surface; and the infrared rays require the signal-emitting direction at an angle facing the front side, so as to transmit the signals, the electronics are restrictedly affected on the design of the infrared transmission.

Therefore, most manufacturers design to open a set of molds made of light-transmissive materials on the appearance of the electronic product, so as to meet the requirements of the infrared module. However, the manufacturing cost is also increased. In this manner, it forces the manufacturers to raise the price of the product to balance the cost requirement. In addition, the layout of the electronics is limited due to the restrictions of the optical characteristics for the infrared rays, and thus the layout design of the product is less flexible. As a result, the excessively dull electronic products without the strong sense of design cannot catch the eyes and arouse the purchasing desire of the current consumers.

In addition, in terms of the strategy for manufacturing the electronic devices, some manufacturers often continue to use the former model but make slight modifications, however, these adjustments on design are merely minor changes on the appearance of the electronic device cases. As for the main changes, only the changes made to the layout of the internal circuit of the electronic device can be called main changes. If the layout position of an infrared receiver is changed in the subsequently produced electronic device, the manufacturer must re-design the mold according to the receiver, such that the manufacturing cost is increased.

In order to enable the infrared receiver to successfully receive the infrared rays transferred from the exterior to the electronic device, a slot must be pre-designed on the case of the conventional electronic product, and then, a light guiding block made of transparent or semi-transparent materials is manufactured by injection through using another mold, which has a size matching with the size of the slot. Then, various combining means, for example, embedding, snapping, latching, and adhering, are used to assemble the light guiding block with the slot. However, the light guiding block and the case are two separate components, such that the light guiding block combined on the case is easily dropped off from the slot due to various factors, for example, impacted by an external force, material deformation, and assembling error, etc.

However, since the case of the electronic product is mostly manufactured by injection molding, the design of the additional slot significantly increases the complexity of the mold used in the injection molding process, and also relatively increases the manufacturing cost. During the assembling process of the electronic device, since the slot matches with the light guiding block, both of them must be accurately aligned and embedded with each other, and as a result, the production efficiency cannot be significantly improved. Furthermore, when assembling the circuit board of the electronic device to the case, due to the errors in the assembling process, the receiver on the circuit board cannot be accurately aligned with the slot of the case, such that the receiver cannot accurately receive the infrared signals emitted from the slot, and thereby causing the problem of the poor transmission of the infrared signals.

In the electronic device, since the slot is disposed on the surface of the case, the structural strength of the case is poor. The case material also forms a breaking point due to the slot, and in the near future, it is extremely possible for the case material to be aging even broken starting from the slot. In terms of the overall aesthetic property of the product, the recess occupies an excessive large area on the case, such that the aesthetic property of the electronic device is severely affected. Therefore, it is difficult for the conventional electronic device with an infrared signal receiving function to satisfy the market trend with high requirements in terms of both practicability and overall appearance.

### SUMMARY OF THE INVENTION

In view of the above problems, the object of the invention provides a case substrate, thereby solving the problems of the electronic device in the conventional art that it is limited by the optical characteristics of the infrared rays, so the manufacturing procedure and cost are increased, the case structural strength is poor, and the device appearance is also limited.

The present invention provides a case substrate, which includes a base material and a coating layer coated on one side of the base material, in which the coating layer has a hollow-out opening corresponding to the position of an infrared receiver, such that infrared rays can pass through the base material from the hollow-out opening and thus being received by the receiver.

The present invention provides a novel case substrate. The coating layer of the case directly forms a hollow-out opening, such that the infrared rays can pass through the base material via the hollow-out opening and thus being directly received by the receiver. The case substrate of the present invention is not limited by the optical characteristics of the infrared rays, and has diversified selectivity on the configurations of the case. During the manufacturing process, the case may be firstly manufactured by injection, and then the hollow-out opening is opened according to the position of the infrared receiver, such that the design of the case is more flexible, and meanwhile it prevents the assembling errors from affecting the transmission of infrared signals. The case substrate of the present invention does not require an additionally recess to be opened therein for accommodating the receiver, such that the overall structural strength is improved, the problem that the parts are easily dropped out is solved, and the aesthetic property is acquired.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1A is a schematic cross-sectional view of a case substrate according to the present invention;

FIG. 1B is a schematic cross-sectional view of the case substrate according to the present invention;

FIG. 2 is a schematic plan view of the case substrate according to the present invention;

FIG. 3A is a schematic perspective view of an electronic device with hollow openings in different configurations according to the present invention;

FIG. 3B is a schematic perspective view of the electronic device with hollow-out openings in different configurations according to the present invention; and

FIG. 3C is a schematic perspective view of the electronic device with hollow-out openings in different configurations according to the present invention.

### DETAILED DESCRIPTION OF THE INVENTION

The case substrate provided by the present invention is applied on an electronic device, in which the electronic device with an infrared signal receiving function, for example, personal computers, notebook computers, personal digital assistants (PDAs), and mobile phones, but the present invention is not limited hereby. In the following detailed description of the present invention, the notebook computer is taken as the most preferred embodiment of the present invention, and the accompanying drawings are only intended to make demonstrations and references, but not to limit the present invention.

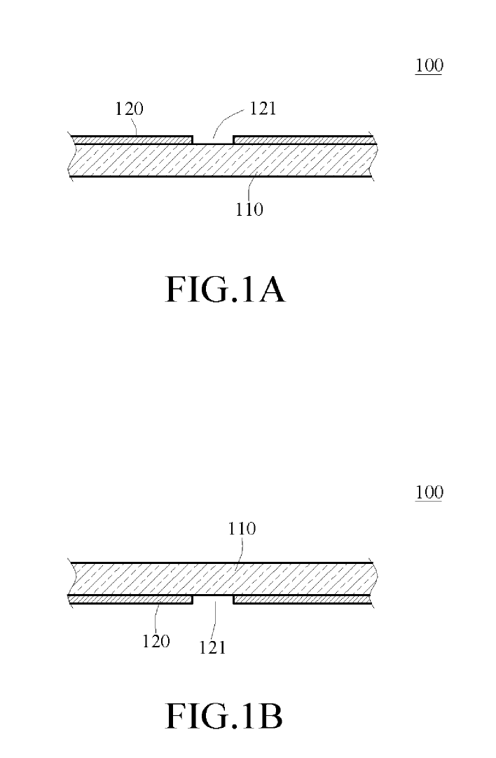

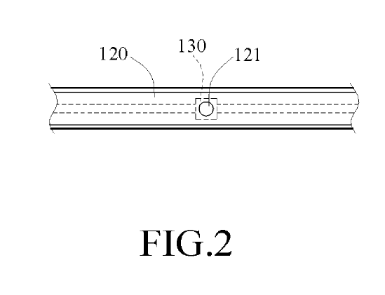

FIGS. 1A and 2 are respectively a schematic cross-sectional view and a schematic plan view of a case substrate according to the present invention. As shown in the figures, a case substrate 100 of the present invention includes a base material 110 and a coating layer 120 coating on a first side of the base material 110. The coating layer 120 has a hollow-out opening 121 for infrared rays to pass through. In addition, as shown in FIG. 1B, the coating layer 120 of the present invention can be selectively coated on a second side of the base material 110.

The base material 110 of the present invention can be made of a transparent material, for example, acrylic materials, e.g., polymethyl methacrylate (PMMA) and polycarbonate (PC) resin, or made of a non-transparent material, for example, germanium(Ge) or polyethylene (PE), which enables the infrared rays to pass through the base material 110. As for the hollow-out opening 121 of the present invention, chemical or physical processes, for example, laser marking, chemical corrosion or milling, can be used to remove a part of the coating layer 120, so as to form the hollow-out opening 121 for the infrared rays to pass through.

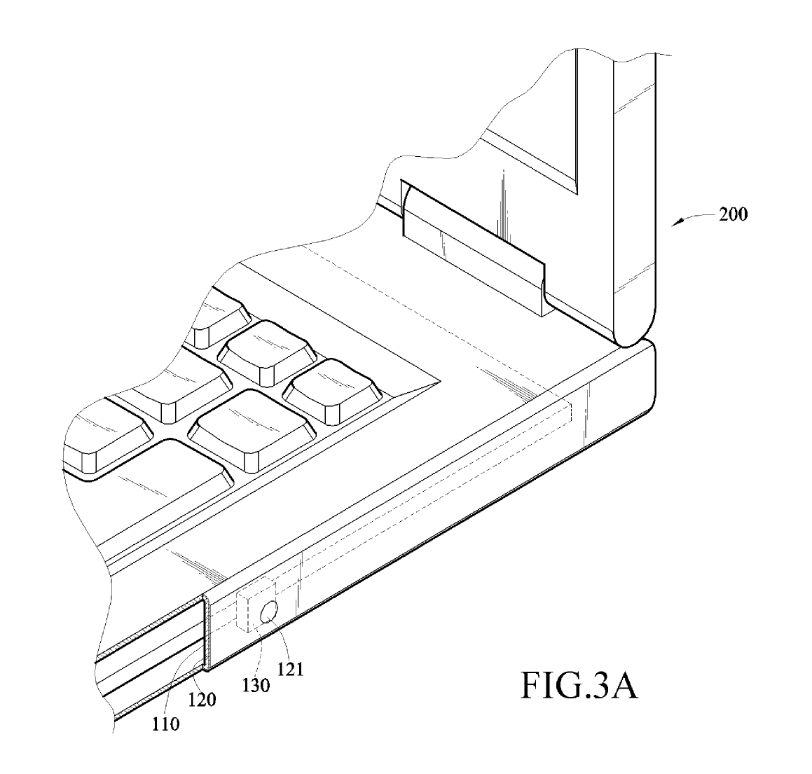

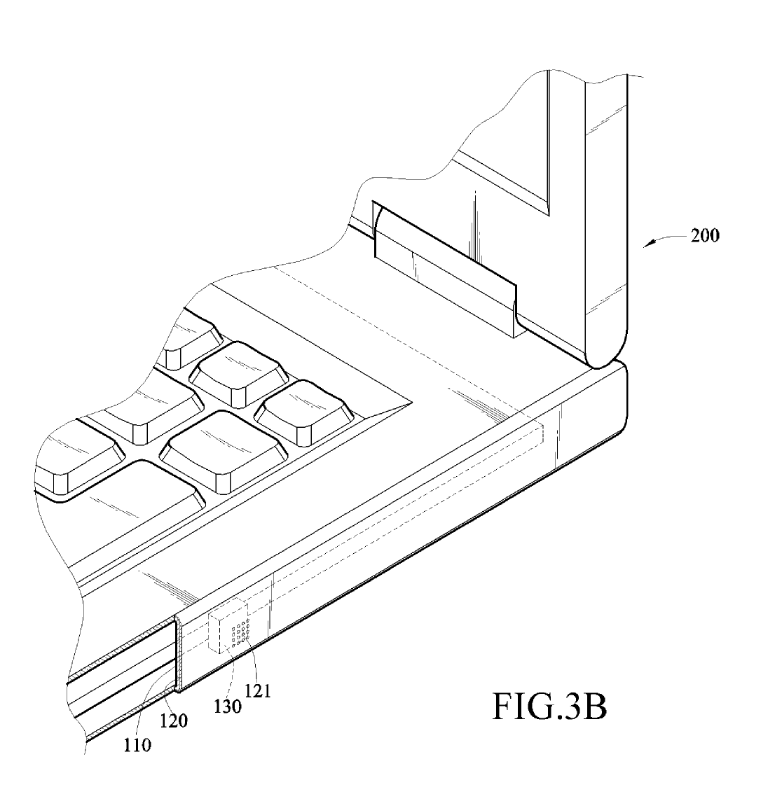

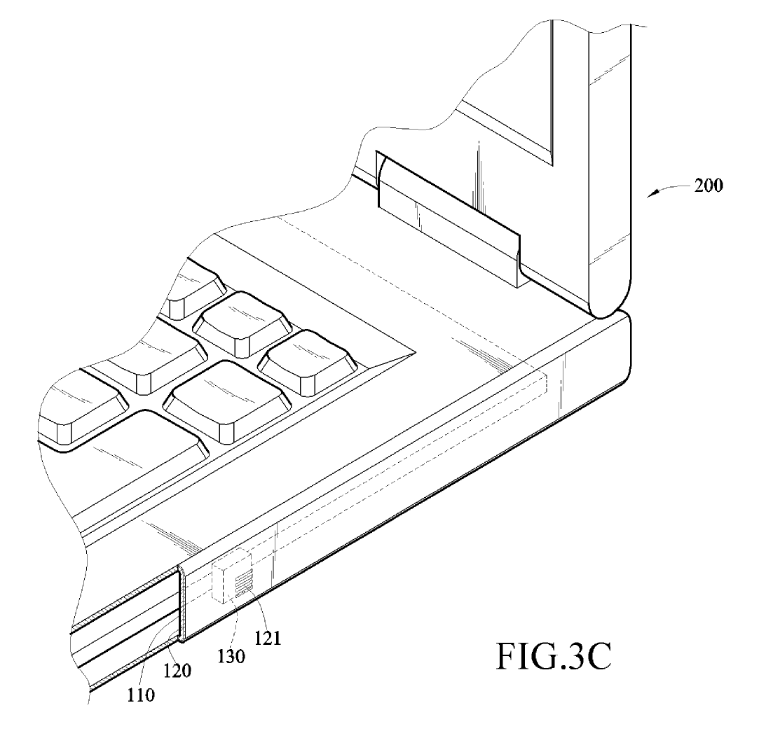

FIG. 3A shows an electronic device structure having an infrared signal receiving function with a case substrate of the present invention being applied therein. An electronic device 200 of the present invention has a receiver 130 therein for receiving the infrared signals. The electronic device structure 200 includes a case substrate 100 having a base material 110 and a coating layer 120 coating an outer side of the base material 100. The coating layer 120 has a hollow-out opening 121 corresponding to the position of the receiver 130, so that the infrared rays pass through the hollow-out opening 121 and the base material 110, and thus being received by the receiver 130 located within the electronic device 200, so as to perform a preset function. The coating layer 120 of the present invention can also coat an inner side of the base material 110 depending upon the process requirements, and since the function achieved here is the same as that achieved when the coating layer 120 coat the outer side of the base material 110, it will not further described repeatedly.

In addition, besides a hollow-out spot region as shown in FIG. 3A, the hollow-out opening 121 of the present invention can be further changed to an array region formed by a plurality of hollow-out pores or an array region formed by a plurality of hollow-out line segments as shown in FIGS. 3B and 3C. Those skilled in the art can also vary the design of the hollow-out opening 121 into an array region with various geometric shapes for the infrared rays to pass through, which is not limited to the embodiments disclosed in the present invention.

The present invention provides a case substrate with a configuration different from that of the conventional art. The infrared rays used to perform the signal transmission can pass through the base material via the hollow-out opening formed on the coating layer, and thus being received by the receiver disposed within the electronic device and corresponding to the hollow-out opening. The case of the present invention can be fabricated first, and then the hollow-out opening is disposed corresponding to the position of the infrared receiver, such that the appearance of the case is not limited by the optical characteristics of the infrared rays and is more flexible in design, and meanwhile, it prevents the assembling errors from affecting the transmission of infrared signals. The case substrate of the present invention does not require an additionally recess to be opened therein for accommodating the receiver, such that no breaking point is formed on the structure of the case, and the overall structural strength is improved accordingly, the problem that the parts are easily dropped out is solved, and the aesthetic property is acquired.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A case substrate, comprising:
a base material; and
a coating layer, disposed on the base material, the coating layer having a hollow-out opening for infrared rays to pass through via the hollow-out opening.

2. The case substrate as claimed in claim 1, wherein the coating layer disposes on a first side of the base material.

3. The case substrate as claimed in claim 1, wherein the coating layer disposes on a second side of the base material.

4. The case substrate as claimed in claim 1, wherein the hollow-out opening is selected from a hollow-out spot region, an array region formed by a plurality of hollow-out pores, or an array region formed by a plurality of hollow-out line segments.

5. The case substrate as claimed in claim 1, wherein the base material is a transparent material.

6. The case substrate as claimed in claim 1, wherein the base material is a non-transparent material.

7. An electronic device structure with an infrared signal receiving function, having a receiver for receiving infrared signals to perform a preset function, comprising:
a case structure, having a base material and a coating layer disposing on the base material, in which the coating layer has a hollow-out opening corresponding to a position of the receiver, so that infrared rays pass through the case structure via the hollow-out opening and thus being received by the receiver.

8. The electronic device structure with the infrared signal receiving function as claimed in claim 7, wherein the coating layer disposes on a first side of the base material.

9. The electronic device structure with the infrared signal receiving function as claimed in claim 7, wherein the coating layer disposes on a second side of the base material.

10. The electronic device structure with the infrared signal receiving function as claimed in claim 7, wherein the hollow-out opening is selected from a hollow-out spot region, an array region formed by a plurality of hollow-out pores, or an array region formed by a plurality of hollow-out line segments.

11. The electronic device structure with the infrared signal receiving function as claimed in claim 7, wherein the base material is a transparent material.

12. The electronic device structure with the infrared signal receiving function as claimed in claim 7, wherein the base material is a non-transparent material.

13. A method of manufacturing a case substrate, wherein a receiver for receiving infrared signals is disposed within the case substrate to perform a preset function, the method comprising:
providing a base material;
providing a coating layer on the base material; and
removing the coating layer corresponding to the position of the receiver to form a hollow-out opening, so that the infrared rays pass through the case structure and thus being received by the receiver.

14. The method of manufacturing the case substrate as claimed in claim 13, wherein the coating layer disposes on a first side of the base material.

15. The method of manufacturing the case substrate as claimed in claim 13, wherein the coating layer disposes on a second side of the base material.

16. The method of manufacturing the case substrate as claimed in claim 13, wherein in the step of removing the coating layer, a laser marking process is used to remove the coating layer and thus forming the hollow-out opening.

17. The method of manufacturing the case substrate as claimed in claim 13, wherein in the step of removing the coating layer, a chemical corrosion process is used to remove the coating layer and thus forming the hollow-out opening.

18. The method of manufacturing the case substrate as claimed in claim 13, wherein in the step of removing the coating layer, a milling process is used to remove the coating layer and thus forming the hollow-out opening.
